(19) United States
(12) Patent Application Publication
(10) Pub. No.: US 2009/0148216 A1
(43) Pub. Date: Jun. 11, 2009

(54) FINISHER AND IMAGE FORMING APPARATUS

(75) Inventor: Makoto ODANI, Shizuoka-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/331,828

(22) Filed: Dec. 10, 2008

Related U.S. Application Data
(60) Provisional application No. 61/012,766, filed on Dec. 10, 2007.

(51) Int. Cl. G03G 15/00

(52) U.S. Cl. 399/410

(57) ABSTRACT

In an image forming apparatus of the invention, a punching unit bores a first hole and a second hole, which are parted from each other by a predetermined distance, in a sheet conveyed from a main body having an image forming unit which forms an image on the sheet; a wire guide feeding/rewinding unit inserts a hollow wire guide into the first hole and the second hole punched in the sheet; a wire feeding unit inserts a wire into the wire guide which is inserted into the first hole and the second hole; a wire holding unit holds the wire inserted into the wire guide; a wire cutting unit cuts the wire; and a wire bending unit bends the wire. Therefore, it is possible to preferably bind a sheet bundle regardless of the thickness of the sheet bundle or the number of sheets in the sheet bundle.

### CROSS-REFERENCE TO RELATED APPLICATION

This application is based upon and claims the benefit of priority from; U.S. provisional application 61/012,766, filed on Dec. 10, 2007, the entire contents of which is incorporated herein by reference.

### TECHNICAL FIELD

The present invention relates to a finisher and an image forming apparatus, and more particularly, to a finisher and an image forming apparatus that can bind a sheet bundle.

### BACKGROUND

Recently, an electrophotographic image forming apparatus, such as a laser printer, a digital copier, and a laser facsimile machine, is provided with a post-processing device (finisher) which binds a sheet bundle. The post-processing device is provided with a stapler to bind the sheet bundle. The stapler staples sheets discharged from an image forming unit.

However, in a manner of binding the sheet bundles by using the stapler, when the sheet bundle to be bound is thick or the number of sheets in the sheet bundle to be bound is large, it is difficult to bind the sheet bundle properly.

### SUMMARY

The invention is made in consideration of the above circumstances, and an object is to provide a finisher and an image forming apparatus, which is able to preferably bind a sheet bundle regardless of the thickness of the sheet bundle or the number of sheets in the sheet bundle.

In order to solve the problems, the finisher according to an aspect of the invention, includes: a punching unit configured to punch a first hole and a second hole, which are parted from each other by a predetermined distance, in a sheet conveyed from a main body having an image forming unit which forms an image on the sheet; a wire guide feeding/rewinding unit configured to insert a hollow wire guide into the first hole and the second hole punched in the sheet by the punching unit; a wire feeding unit configured to insert a wire into the wire guide which is inserted into the first hole and the second hole by the wire guide feeding/rewinding unit; a wire holding unit configured to hold the wire inserted into the wire guide by the wire feeding unit; a wire cutting unit configured to cut the wire; and a wire bending unit configured to bend the wire.

In order to solve the problems, the image forming apparatus according to an aspect of the invention, includes a main body having an image forming unit forming an image on a sheet and a finisher, wherein the finisher includes: a punching unit configured to punch a first hole and a second hole, which are parted from each other by a predetermined distance, in a sheet conveyed from the main body; a wire guide feeding/rewinding unit configured to insert a hollow wire guide into the first hole and the second hole punched in the sheet by the punching unit; a wire feeding unit configured to insert a wire into the wire guide inserted into the first hole and the second hole by the wire guide feeding/rewinding unit; a wire holding unit configured to hold the wire inserted into the wire guide by the wire feeding unit; a wire cutting unit configured to cut the wire; and a wire bending unit configured to bend the wire.

### DESCRIPTION OF THE DRAWINGS

In accompanied drawings,

FIG. 1 is a descriptive diagram schematically illustrating a method of binding a sheet bundle according to the invention;

FIG. 2 is a diagram illustrating appearance of punching two holes in a sheet by using a punching unit;

FIGS. 3A and 3B are diagrams illustrating a method to insert a wire guide into holes P-1 and P-2 punched in one sheet;

FIG. 4 is a diagram illustrating appearance of wire guides to be inserted into holes of one sheet or several stacked sheets;

FIGS. 5A and 5B are diagrams illustrating a method to place a U-shaped guide at a leading end of each wire guide;

FIG. 6 is a diagram illustrating a method to insert a wire into a wire guide;

FIG. 7 is a diagram illustrating appearance of pulling out a wire guide after the wire passes through a sheet bundle along the wire guide;

FIG. 8 is a diagram illustrating a method to separate a U-shaped guide;

FIG. 9 is a diagram illustrating a method to cut one side of a wire in a state of being pulled in a direction to a sheet bundle;

FIG. 10 is a diagram illustrating a method to bend a leading end at either side of a wire;

FIG. 11 is a diagram illustrating an entire image forming apparatus according to an embodiment;

FIG. 12 is a diagram illustrating an internal configuration of a finisher shown in FIG. 11;

FIGS. 13A and 13B are diagrams illustrating a configuration of a punching unit;

FIG. 14 is a diagram illustrating appearance of a wire guide which returns up to the height of piled sheets;

FIGS. 15A to 15C are diagrams illustrating a method to separate a U-shaped guide by a wire guide separating mechanism;

FIG. 16 is a diagram illustrating a wire guide which is connected to a U-shaped guide by lifting up the wire guide;

FIG. 17 is a diagram illustrating a wire guide which is separated from a U-shaped guide by lifting the wire guide down;

FIGS. 18A and 18B are diagrams specifically illustrating a method to hold a wire with a wire pressing mechanism; and

FIGS. 19A and 19B is a diagram specifically illustrating a method to bend a wire.

### DETAILED DESCRIPTION

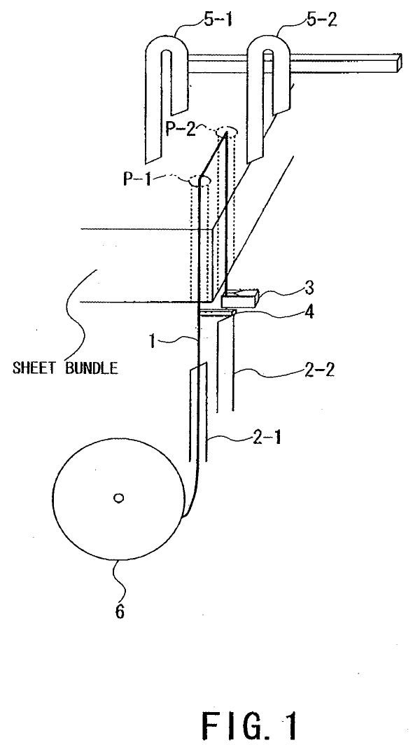

Hereinafter, an embodiment will be described with reference to drawings. Here, before preceding the description of the embodiment, the concept of the invention will be described. As shown in FIG. 1, small holes P-1 and P-2 are previously punched in a sheet bundle, and wire guides 2-1 and 2-2 are passed through the holes P-1 and P-2. After that, a thin wire 1 is passed through the wire guides 2-1 and 2-2. The wire 1 is cut in necessary length and thereafter folded.

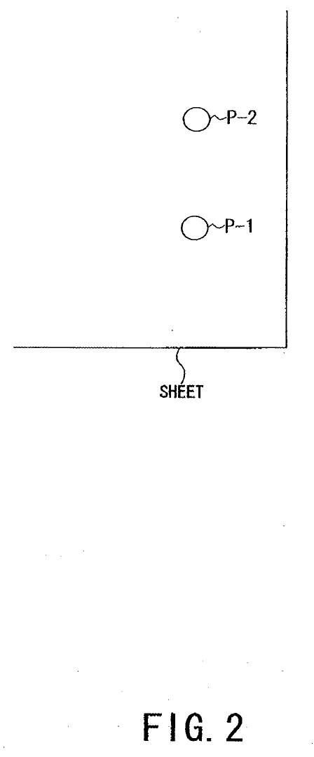

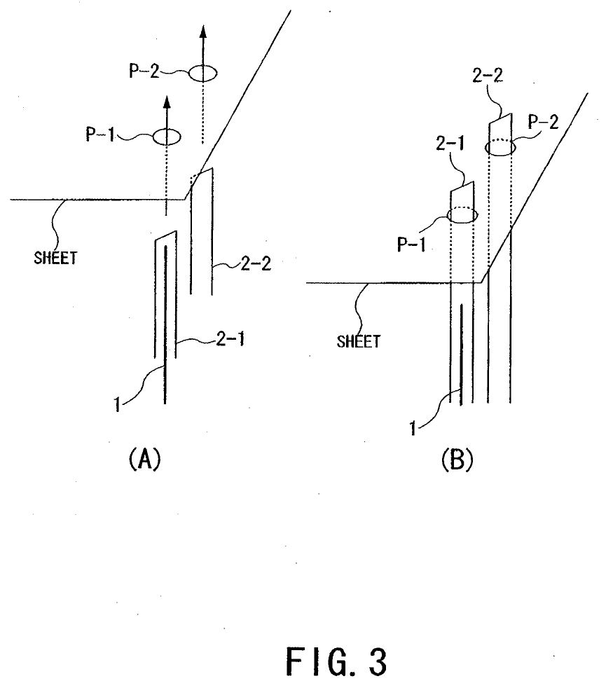

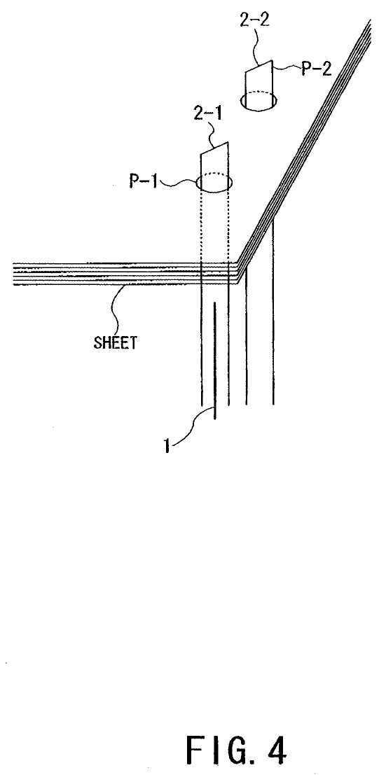

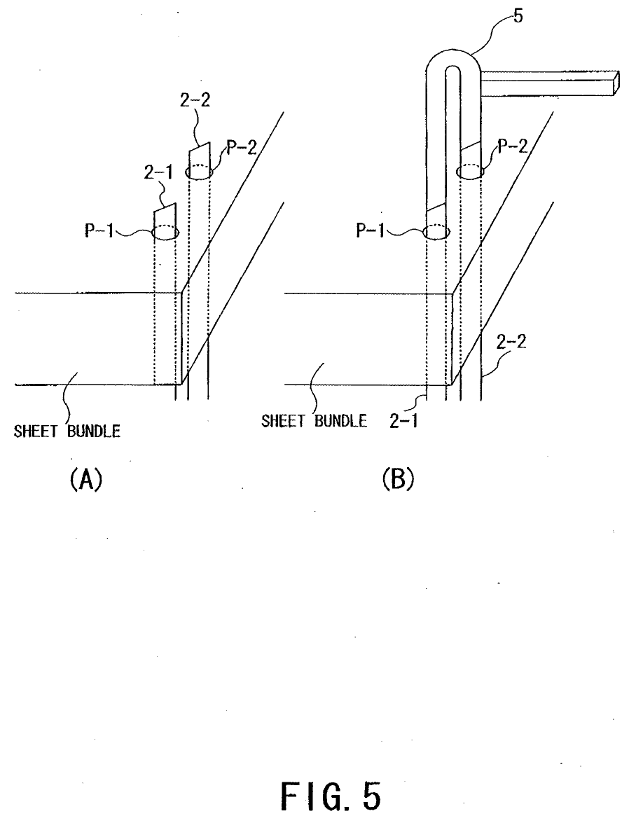

Specifically, as shown in FIG. 2, the holes P-1 and P-2 of about 1 mm to 3 mm are punched in a sheet by the use of a hole punch (punching unit). At this time, the holes P-1 and P-2 are punched in the sheets one by one or together. The holes P-1 and P-2 are separated from each other by about 1 cm to 2 cm. The sheets, in which such two holes (holes P-1 and P-2) are punched, are sequentially piled. At this time, as shown in FIGS. 3A and 3B, first, each of wire guides 2-1 and 2-2 is inserted into the holes P-1 and P-2 punched in one sheet in an arrow direction, respectively. The wire guides 2-1 and 2-2 are separated from each other by the same distance as the distance between the holes P-1 and P-2. Then, as shown in FIG. 4, the wire guides 2-1 and 2-2 pass through the holes of the sheet one by one or together. Therefore, as shown in FIG. 5A, a sheet bundle to be bound is stacked.

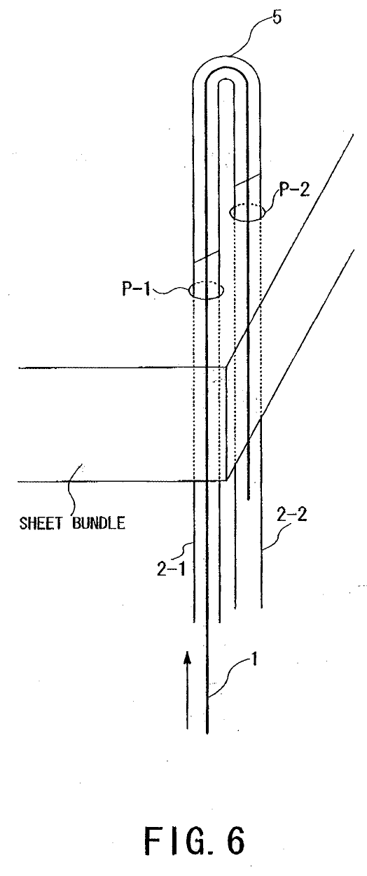

As shown in FIG. 5B, after the sheet bundle to be bound is stacked, a U-shaped guide 5 is placed at a leading end of each wire guide 2-1 and 2-2 in order to connect the two wire guides 2-1 and 2-2. When the U-shaped guide 5 is placed at the wire guides 2-1 and 2-2, the wire 1 is inserted into one of the wire guides 2-1 and 2-2 as shown in FIG. 6. For example, the wire 1 is inserted into the wire guide 2-1. Notably, the wire 1 may be inserted into the wire guide 2-2. The wire 1 passes from the wire guide 2-1 in an inserting side to the wire guide 2-2 in an opposite side, and then passes through the sheet bundle along the wire guide 2-2.

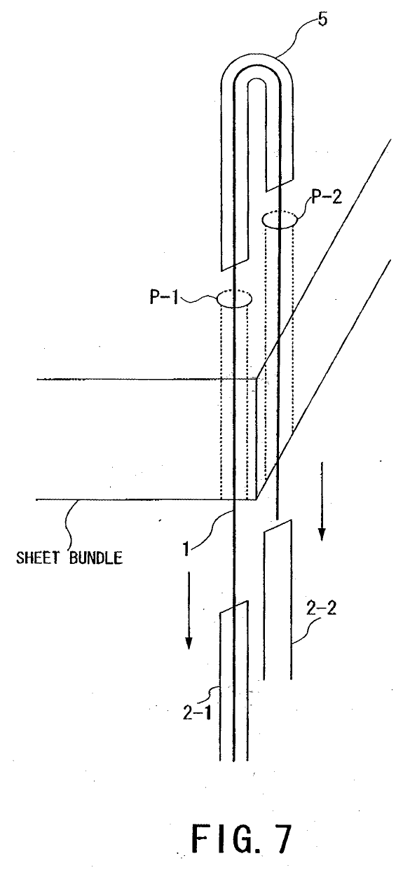

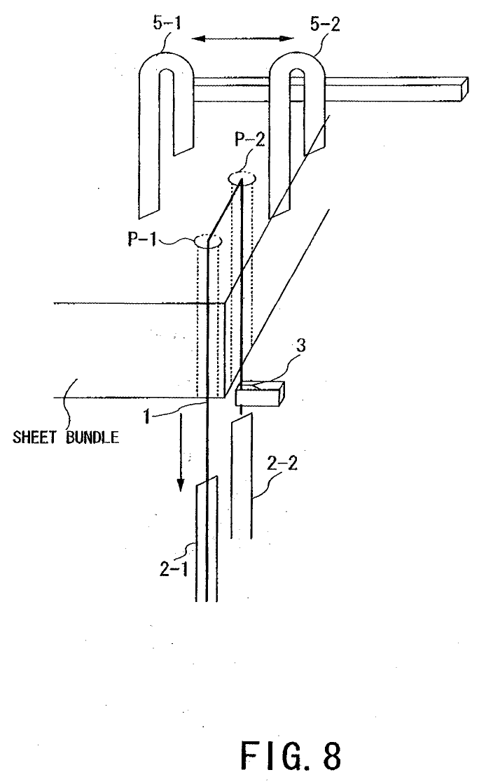

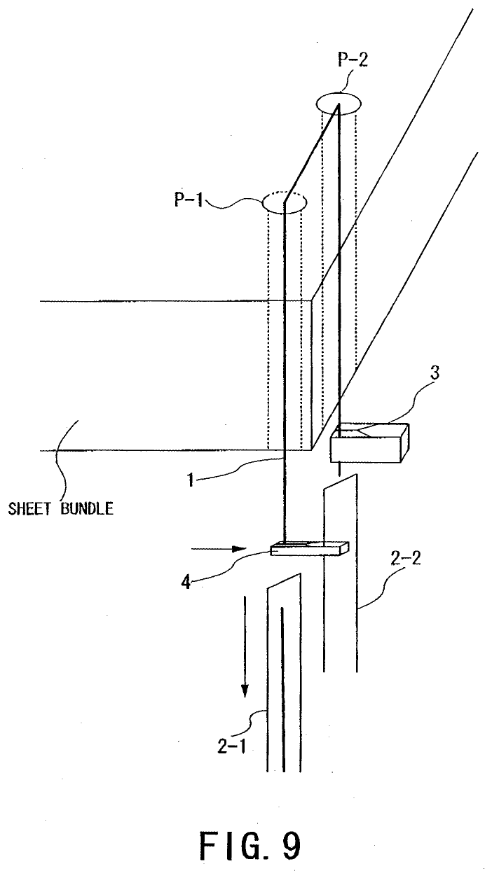

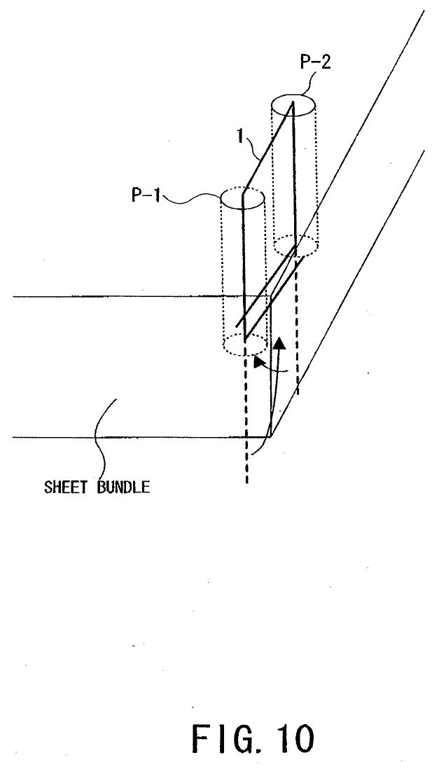

As shown in FIG. 7, after the wire 1 passes through the sheet bundle along the wire guide 2-2, the wire guides 2-1 and 2-2 are pulled out in arrow directions. The wire 1 is exposed to the outside after the wire guides 2-1 and 2-2 are pulled out. The leading end portion of the wire 1 exposed to the outside is pressed by a wire pressing mechanism 3 not to fall off the holes P-1 and P-2. As shown in FIG. 8, the U-shaped guide 5 has a structure capable of separating into two parts, so that the U-shaped guide is able to be separated into the U-shaped guides 5-1 and 5-2 if needed. After the wire pressing mechanism 3 presses the leading end of the wire 1, if the wire 1 is pulled back while the U-shaped guides 5-1 and 5-2 are separated, or if the wire 1 is pulled back without the wire guides 2-1 and 2-2 in the sheet bundle, the wire 1 falls away from the U-shaped guide 5 and is pulled down in a direction of the sheet bundle. As shown in FIG. 9, in the state that the wire 1 is pulled down in the direction of the sheet bundle, one side of the wire 1 is cut by a wire cutter mechanism 4, so that the wire 1 is cut in necessary length. As shown in FIG. 10, the leading ends of both sides of the wire 1 are bent inwardly, respectively. The wire 1, which is used for binding the sheet bundle, may have elasticity. Therefore, it is possible to bind a thick sheet or a sheet bundle having a large number of sheets easily instead of using strong force similar to a stapler.

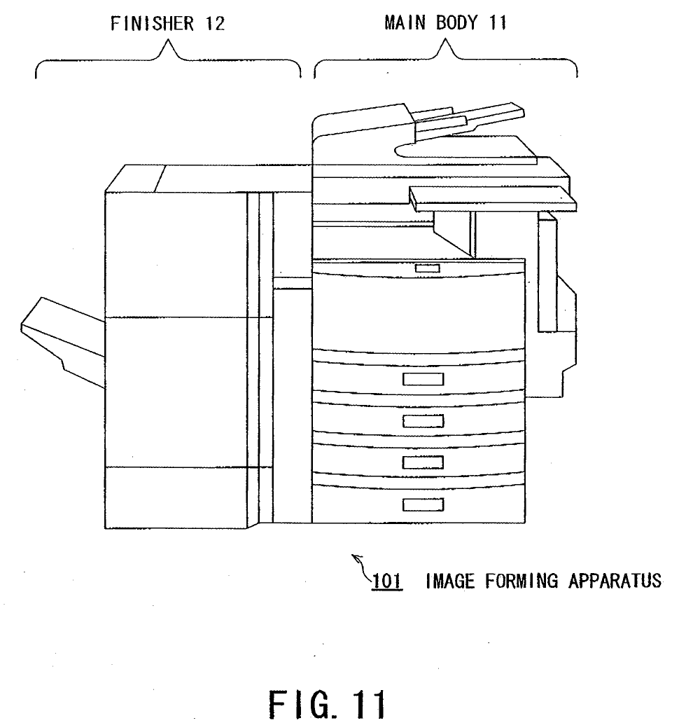

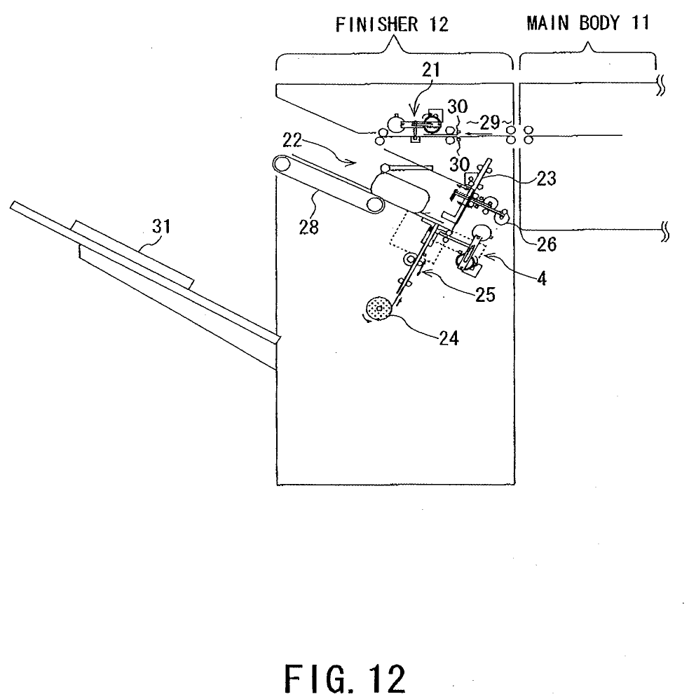

FIG. 11 shows a diagram illustrating an entire image forming apparatus 101 according to the embodiment. As shown in FIG. 11, the image forming apparatus 101 is provided with a main body 11 having an image forming unit and a finisher 12. FIG. 12 shows a diagram illustrating an internal configuration of the finisher 12 shown in FIG. 11. As shown in FIG. 12, the finisher 12 is provided with a punching unit 21, a sheet stack unit 22, a sheet pressing mechanism 23, a wire feeding unit 24, a wire guide feeding/rewinding unit 25, a wire guide separating mechanism 26, a wire cutter mechanism 4, a sheet discharging mechanism 28, a punching timing sensor 30, and a sheet tray 31.

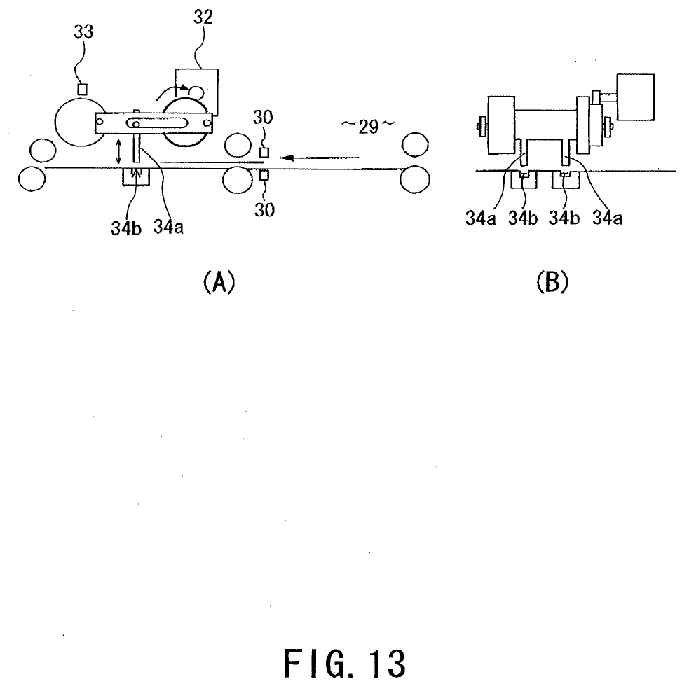

The sheet, which is conveyed from the main body 11 via a sheet conveying path 29, passes through the punching timing sensor 30 to be supplied to the punching unit 21. FIGS. 13A and 13B show diagrams illustrating a configuration of the punching unit 21. FIG. 13A shows a side view of the punching unit 21. FIG. 13B shows a front view of the punching unit 21. As shown in FIGS. 13A and 13B, the punching unit 21 is provided with a punching driving motor 32 and a punch reference position detecting sensor 33. The punching timing sensor 30 is provided in the vicinity of the punching unit 21. When the sheet is inserted into the sheet conveying path 29, the punching timing sensor 30 detects a tail end of the sheet. The punching driving motor 32 is driven at timing when the punching timing sensor 30 detects the tail end of the sheet. Two punch blades 34a moves up and down according to the driving of the punching driving motor 32. Therefore, two places of holes are punched in the sheet. In addition, a groove 34b is provided at a position corresponding to the position of the punch blade 34a to be engaged with the punch blade 34a.

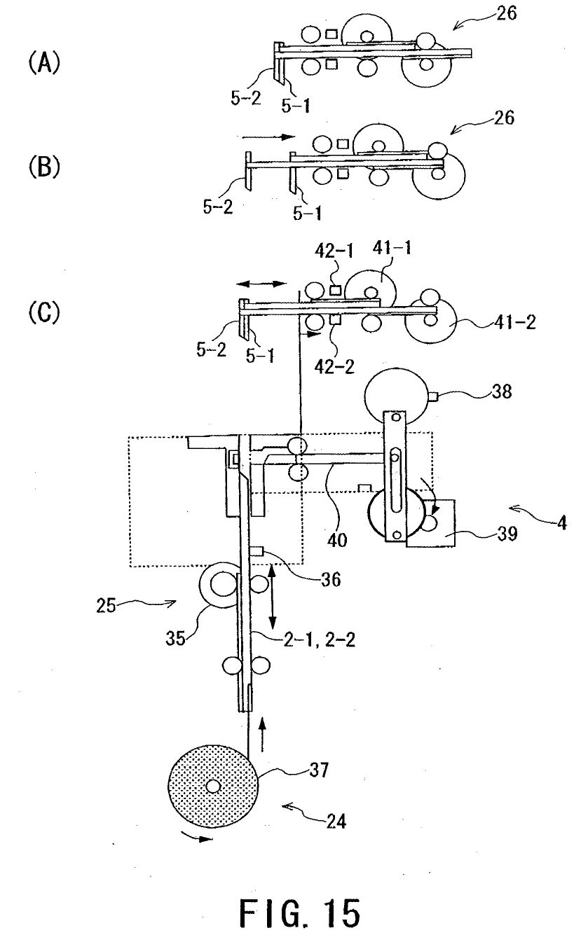

The sheet where two places of holes are punched by the punching unit 21 is discharged from the sheet conveying path 29 to the sheet stack unit 22 after adjusting a sheet discharging speed and is fallen to the sheet stack unit 22. The sheet fallen to the sheet stack unit 22 is arranged by a sheet guide. After the sheet is arranged by the sheet guide, the sheet pressing mechanism 23 is driven. The sheet pressing mechanism 23 presses the sheet with necessary force. Then, the wire guide feeding/rewinding unit 25 is driven, the wire guides 2-1 and 2-2 are inserted into the two places of holes punched in the sheet. Further, as shown in FIG. 15C described later, the wire guide feeding/rewinding unit 25 is provided with a wire guide driving motor 35 and a wire guide position detecting sensor 36 which detects positions of the wire guide 2 (2-1 and 2-2). When the wire guides 2-1 and 2-2 are fed, the wire guide driving motor 35 of the wire guide feeding/rewinding unit 25 is driven.

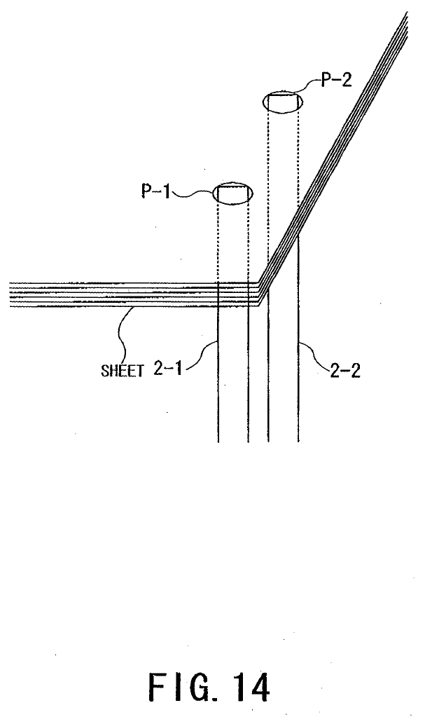

When the wire guides 2-1 and 2-2 are inserted into the two places of holes punched in the sheet, as shown in FIG. 14, the wire guides 2-1 and 2-2 are returned up (rewound) to the height of the piled sheets by driving the wire guide feeding/rewinding unit 25. After that, the sheet pressing mechanism 23 rises to separate from the sheet. This series of processes are repeated according to the number of the sheets to be bound.

When the last sheet to be bound is fallen to the sheet stack unit 22, the sheet pressing mechanism 23 presses the sheets with necessary force. The wire guide feeding/rewinding unit 25 is driven and the wire guides 2-1 and 2-2 rise. As a result, as shown in FIGS. 5A and 5B described above, the U-shaped guide 5 is placed at the leading ends of the wire guides 2-1 and 2-2 in order to connect the two wire guides 2-1 and 2-2.

FIG. 15 shows a diagram illustrating a method to separate the U-shaped guide 5 by the wire guide separating mechanism 26. FIG. 15A shows the U-shaped guide 5 contained before being separated by the wire guide separating mechanism 26. FIG. 15B shows a diagram illustrating the U-shaped guide 5 separated by the wire guide separating mechanism 26. FIG. 15C shows a diagram illustrating a configuration of the wire guide separating mechanism 26.

As shown in FIG. 15A, the two U-shaped guides 5-1 and 5-2 constituting the U-shaped guide 5 are contained before being separated by the wire guide separating mechanism 26. As shown in FIG. 15B, when being separated by the wire guide separating mechanism 26, the two U-shaped guides 5-1 and 5-2 constituting the U-shaped guide 5 are separated by a predetermined distance. Here, as shown in FIG. 15C, the wire guide separating mechanism 26 is provided with the U-shaped guide 5-1 as a upper guide of the U-shaped guide 5, the U-shaped guide 5-2 as a lower guide of the U-shaped guide 5, a upper wire guide driving motor 41-1 driving the U-shaped guide 5-1, a lower wire guide driving motor 41-2 driving the U-shaped guide 5-2, a upper wire guide reference position detecting sensor 42-1, and a lower wire guide reference position detecting sensor 42-2. Further, the U-shaped guides 5-1 and 5-2 can individually drive.

After that, as shown in FIG. 15C, the wire feeding unit 24 drives a wire cartridge motor (DC motor) 43, rotates a wire cartridge 37, and feeds the wire 1 winding on the wire cartridge 37. The wire 1 fed from the wire feeding unit 24 is inserted into any one of the wire guides 2-1 and 2-2. The wire 1 passes through the sheet bundle along the wire guide 2-2. When the wire feeding unit 24 feeds the wire 1 by a necessary amount along the wire guide, the wire feeding unit 24 stops the wire cartridge motor 43 from rotating. Then, the wire guide driving motor 35 of the wire guide feeding/rewinding unit 25 is driven to lift the wire guides 2-1 and 2-2 down.

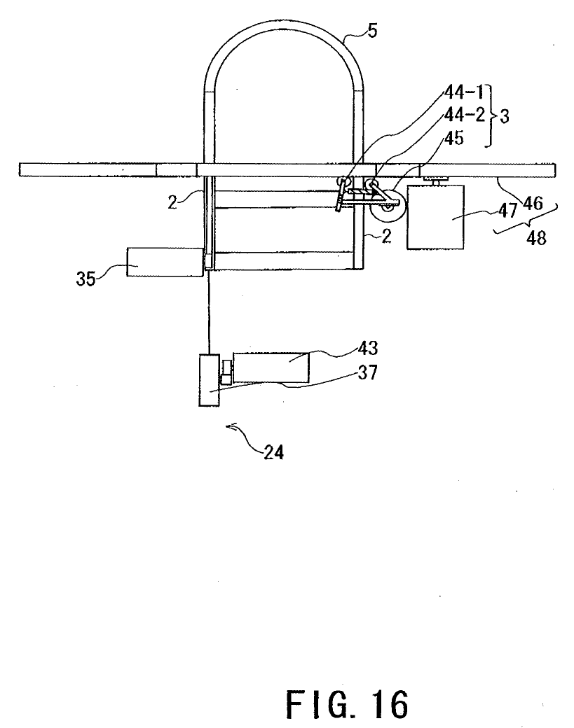

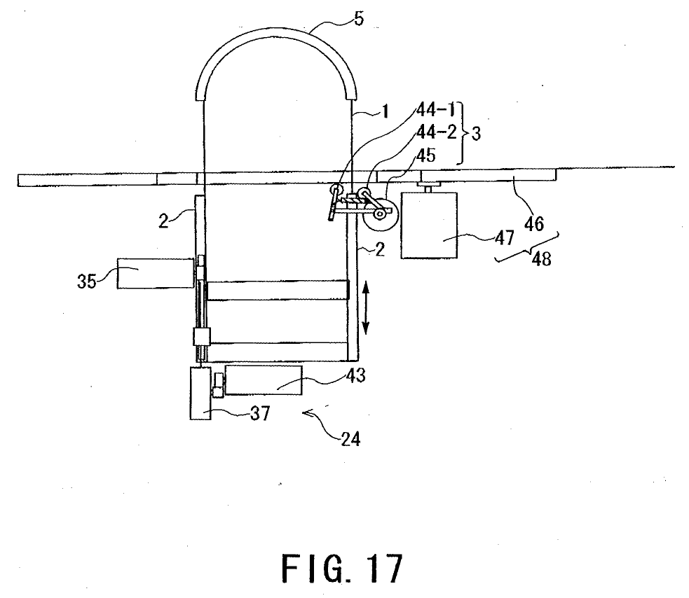

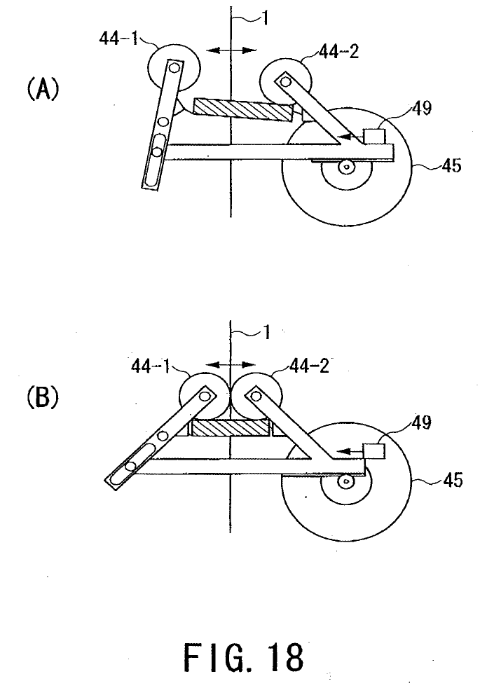

FIG. 16 shows a state where the wire guides 2-1 and 2-2 are lifted up so as to connect the wire guides 2-1 and 2-2 with the U-shaped guide 5. FIG. 17 shows a state where the wire guides 2-1 and 2-2 are lifted down so as to disconnect the wire guides 2-1 and 2-2 from the U-shaped guide 5. After the wire guides 2-1 and 2-2 are pulled out, the wire 1 is exposed to the outside. The leading end portion of the wire 1 exposed to the outside is pressed by the wire pressing mechanism 3 not to fall off the holes P-1 and P-2. As shown in FIGS. 16 and 17, the wire pressing mechanism 3 is provided with wire pushers 44-1 and 44-2 and a wire pusher driving motor 45. The wire pressing mechanism 3 drives the wire pusher driving motor 45 and holds the wire 1 with the wire pushers 44-1 and 44-2. FIGS. 18A and 18B specifically show a method to hold the wire 1 with the wire pressing mechanism 3. As shown in FIG. 18A, the wire pushers 44-1 and 44-2 are separated from each other by a predetermined distance, and the wire 1 is not supported by the wire pushers 44-1 and 44-2. On the other hand, as shown in FIG. 18B, the distance between the wire pushers 44-1 and 44-2 comes to be short according to the driving of the wire pusher driving motor 45. Finally, the wire pushers 44-1 and 44-2 are contacted with each other to hold the wire 1. As shown in FIGS. 18A and 18B, a wire pressed state sensor 49 is provided in the vicinity of the wire pusher 44-2, which detects the state that the wire 1 is held by the wire pushers 44-1 and 44-2.

When the wire 1 is held by the wire pushers 44-1 and 44-2, the upper wire guide driving motor 41-1 and the lower wire guide driving motor 41-2 are driven, and the two U-shaped guides 5-1 and 5-2 constituting the U-shaped guide 5 are separated from each other by a predetermined distance. The wire cartridge 37 is rotated by the wire cartridge motor 43 in a direction opposite to that in the case of sending the wire 1, so that the wire 1 is pulled back. When the wire 1 is pulled back by a necessary amount, the slack in the wire is taken up. At this time, the load of the wire cartridge motor 43 increases. The wire feeding unit 24 detects the increase in load of the wire cartridge motor 43 based on the increase in current, and stops the wire cartridge motor 43 from driving.

The wire cutter mechanism 4 drives a wire cutter driving motor 39, feeds a wire cutter 40, and cuts the wire 1 using the fed wire cutter 40. Here, as shown in FIG. 15C, the wire cutter mechanism 4 is provided with a wire cutter reference position detecting sensor 38, the wire cutter driving motor 39, and the wire cutter 40.

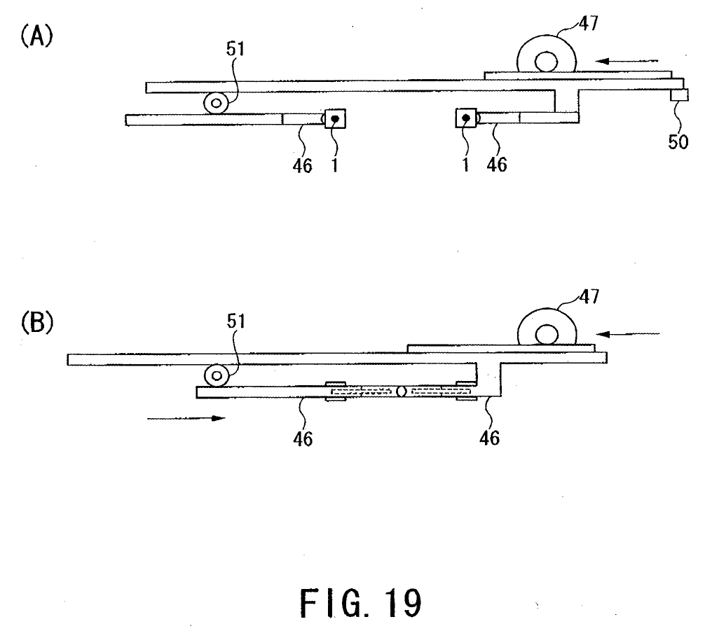

Then, a wire bending mechanism 48 drives a wire bending mechanism driving motor 47 to bend the wire 1. FIGS. 19A and 19B specifically show a method to bend the wire 1. FIG. 19A shows a standby state of the wire bending mechanism 48 before bending the wire 1. FIG. 19B shows a state of the wire bending mechanism 48 at the time of bending the wire 1. As shown in FIGS. 19A and 19B, the wire bending mechanism 48 is provided with a wire bending guide 46, the wire bending mechanism driving motor 47, a wire bending guide reference position sensor 50, and a reverse gear 51. When the wire 1 is bent, the wire bending mechanism 48 drives the wire bending mechanism driving motor 47 so as to move the two wire bending guides 46 facing each other to be closed to each other, so that the wire 1 is bent. Therefore, the sheet bundle is bound by the wire 1 (see FIG. 10).

Then, the sheet discharging mechanism 28 discharges the sheets bound with the wire 1 to the sheet tray 31.

According to the embodiment of the invention, the image forming apparatus 101 is provided with the main body 11 having the image forming unit forming an image on a sheet and the finisher 12, wherein the finisher 12 includes: the punching unit 21 punching a first hole (hole P-1) and a second hole (hole P-2), which are parted from each other by a necessary distance, in a portion of a sheet conveyed from the main body 11; the wire guide feeding/rewinding unit 25 inserting the hollow wire guide 2 (2-1 and 2-2) into the first hole and the second hole punched in the sheet by the punching unit 21; the wire feeding unit 24 inserting the wire 1 into the wire guide 2 inserted into the first hole and the second hole by the wire guide feeding/rewinding unit 25; the wire holding unit (wire pressing mechanism) 3 holding the wire 1 inserted into the wire guide 2 by the wire feeding unit 24; the wire cutting unit (wire cutter mechanism 4) cutting the wire 1; and the wire bending unit (wire bending mechanism 48) bending the wire 1. Therefore, the sheet bundle is able to be preferably bound regardless of the thickness of the sheet bundle or the number of sheets in the sheet bundle.

What is claimed is:

1. A finisher comprising:
a punching unit configured to punch a first hole and a second hole, which are parted from each other by a predetermined distance, in a sheet conveyed from a main body having an image forming unit which forms an image on the sheet;
a wire guide feeding/rewinding unit configured to insert a hollow wire guide into the first hole and the second hole punched in the sheet by the punching unit;
a wire feeding unit configured to insert a wire into the wire guide which is inserted into the first hole and the second hole by the wire guide feeding/rewinding unit;
a wire holding unit configured to hold the wire inserted into the wire guide by the wire feeding unit;
a wire cutting unit configured to cut the wire; and
a wire bending unit configured to bend the wire.

2. The finisher according to claim 1, further comprising a sheet detecting unit configured to detect the sheet conveyed from the main body via a sheet conveying path,
wherein the punching unit punches the first hole and the second hole in the sheet at timing when the sheet detecting unit detects the sheet.

3. The finisher according to claim 1, wherein the punching unit includes a punch blade to punch the first hole and the second hole in the sheet.

4. The finisher according to claim 3, wherein the punching unit further includes a groove which is provided at a position corresponding to the punch blade and is engaged with the punch blade.

5. The finisher according to claim 1, further comprising:
a sheet stack unit configured to sequentially stack one sheet or a plurality of sheets punched with the first hole and the second hole by the punching unit; and
a sheet pressing unit configured to press the sheet stacked by the sheet stack unit with predetermined force,
wherein the wire guide feeding/rewinding unit inserts the wire guide into the first hole and the second hole punched in the sheet in a state pressed by the sheet pressing unit.

6. The finisher according to claim 1, wherein the wire guide inserted into the first hole and the second hole by the wire guide feeding/rewinding unit is connected with a hollow U-shaped guide.

7. The finisher according to claim 6, wherein if the wire guide is connected with the U-shaped guide, the wire feeding unit inserts the wire into the wire guide from one end side of the wire guide.

8. The finisher according to claim 7, wherein the wire inserted into the wire guide from one end side of the wire guide is pushed out from an opening at the other end side of the wire guide through the U-shaped guide.

9. The finisher according to claim 8, wherein if the wire is pushed out from the opening at the other end side of the wire guide, the wire guide feeding/rewinding unit removes the wire guide from the first hole and the second hole, and the wire holding unit holds one end side of the wire exposed between the removed wire guide and the first hole or the second hole.

10. The finisher according to claim 9, wherein if one end side of the wire is held by the wire holding unit, the wire feeding unit pulls the other end side of the wire back by a predetermined amount.

11. The finisher according to claim 9, wherein the wire cutting unit cuts the other end side of the wire.

12. The finisher according to claim 11, wherein the wire bending unit bends the wire both at one end side of the wire and the other end side of the wire cut by the wire cutting unit to bind the sheet with the wire.

13. An image forming apparatus comprising a main body having an image forming unit forming an image on a sheet and a finisher, wherein the finisher includes:
a punching unit configured to punch a first hole and a second hole, which are parted from each other by a predetermined distance, in a sheet conveyed from the main body;
a wire guide feeding/rewinding unit configured to insert a hollow wire guide into the first hole and the second hole punched in the sheet by the punching unit;
a wire feeding unit configured to insert a wire into the wire guide inserted into the first hole and the second hole by the wire guide feeding/rewinding unit;
a wire holding unit configured to hold the wire inserted into the wire guide by the wire feeding unit;
a wire cutting unit configured to cut the wire; and
a wire bending unit configured to bend the wire.

14. The apparatus according to claim 13, further comprising a sheet detecting unit which configured to detect the sheet conveyed from the main body via a sheet conveying path,
wherein the punching unit punches the first hole and the second bole in the sheet at timing when the sheet detecting unit detects the sheet.

15. The apparatus according to claim 13, wherein the punching unit includes a punch blade to punch the first hole and the second hole in the sheet.

16. The apparatus according to claim 15, wherein the punching unit further includes a groove which is provided at a position corresponding to the punch blade and is engaged with the punch blade.

17. The apparatus according to claim 13, further comprising:
a sheet stack unit configured to sequentially stack one sheet or a plurality of sheets punched with the first hole and the second hole by the punching unit; and
a sheet pressing unit configured to press the sheet stacked by the sheet stack unit with predetermined force,
wherein the wire guide feeding/rewinding unit configured to insert the wire guide into the first hole and the second hole punched in the sheet in a state pressed by the sheet pressing unit.

18. The apparatus according to claim 13, wherein the wire guide inserted into the first hole and the second hole by the wire guide feeding/rewinding unit is connected with a hollow U-shaped guide.

19. The apparatus according to claim 18, wherein if the wire guide is connected with the U-shaped guide, the wire feeding unit inserts the wire into the wire guide from one end side of the wire guide.

20. The apparatus according to claim 19, wherein the wire inserted into the wire guide from one end side of the wire guide is pushed out from an opening at the other end side of the wire guide through the U-shaped guide.

21. The apparatus according to claim 20, wherein if the wire is pushed out from the opening at the other end side of the wire guide, the wire guide feeding/rewinding unit removes the wire guide from the first hole and the second hole, and the wire holding unit holds one end side of the wire exposed between the removed wire guide and the first hole or the second hole.

22. The apparatus according to claim 21, wherein if one end side of the wire is held by the wire holding unit, the wire feeding unit pulls the other end side of the wire back by a predetermined amount.

23. The apparatus according to claim 21, wherein the wire cutting unit cuts the other end side of the wire.

24. The apparatus according to claim 23, wherein the wire bending unit bends the wire both at one end side of the wire and the other end side of the wire cut by the wire cutting unit to bind the sheet with the wire.
